(19) United States
(12) Patent Application Publication
(10) Pub. No.: US 2014/0083300 A1
(43) Pub. Date: Mar. 27, 2014

(54) BEVERAGE DISPENSER WITH REMOVABLE NOZZLE ROTATING MODULE

(71) Applicant: NESTEC S.A., Vevey (CH)

(72) Inventors: Yann Brunner, Nuvilly (CH); Alexis Reust, Lausanne (CH); Stefan Brauchle, Hergatz (DE)

(73) Assignee: NESTEC S.A., Vevey (CH)

(21) Appl. No.: 14/119,640

(22) PCT Filed: May 22, 2012
(86) PCT No.: PCT/EP12/59467

§ 371 Date: Nov. 22, 2013

(30) Foreign Application Priority Data
May 27, 2011 (EP) 11167794.4

(51) Int. Cl. A47J 31/46

(52) U.S. Cl. CPC A47J 31/46
USPC 99/283; 99/300; 29/890.14

(57) ABSTRACT

The invention concerns a beverage dispenser (10) in which the beverage is prepared by introducing at least one jet of diluent in a recipient comprising a soluble food ingredient, wherein said dispenser comprises at least one removable rotating jet(s) module (M) comprising: a motor (1) connectable to an energy supply, a diluent nozzle (2) able to deliver at least one jet of diluent and connectable to a diluent supply, a gearing device (3) configured for making the motor rotate the diluent nozzle.

### FIELD OF THE INVENTION

The present invention relates to a beverage dispenser preparing beverages by introducing at least one jet of diluent in a recipient comprising a soluble food ingredient and rotating the jet of diluent.

### BACKGROUND OF THE INVENTION

It is known to prepare beverages by mixing a beverage concentrate such as a dry powder or a liquid concentrate with a diluent such as cold or hot water. One way to implement the mixing of the concentrate and the diluent is the so-called in-cup mixing where the beverage concentrate is introduced into a receptacle and then, the cup is placed below an outlet of a dilution nozzle which introduces at least a stream or jet of diluent to the cup in order to enable an interaction of the beverage concentrate and the diluent. Accordingly, the beverage concentrate is dissolved and eventually frothed by the diluent in order to prepare the beverage.

To improve the dissolution and the frothing of in-cup mixing it has been proposed to rotate either the cup or the dilution nozzle during the introduction of the diluent. For example the publications GB 1 367 354, EP 373 126, EP 1 155 646 describe the rotation of the dilution nozzle above a cup during the injection of the diluent by means of a jets rotating device.

In the jets rotating devices of the prior art it has been observed that when the device must repaired or cleaned, the disconnection of the device is not operator friendly. Often the device is attached to the housing of the dispenser by means of screws and the disconnection needs time and specific tools. Besides once disengaged from the dispenser, the rotating jet(s) device is often on its own difficult to dismount and repair.

Moreover each device is built to define a jet(s) rotation speed and a jet(s) orientation is usually defined that are specific for preparing a beverage:

in a cup presenting a particular shape especially concerning its size, the surface of its bottom, the angle of its walls, and

from a beverage concentrate that has particular dissolution properties. If the device is used with another type of cup, then the jet(s) of the device may not correctly mix the food ingredient at the bottom of the cup and the device should be redesigned. If the concentrate is a highly viscous liquid or a powder with low dissolution properties, the speed of the rotation of the nozzles may be changed.

One aim of the present invention is to solve these problems and to propose a beverage dispenser comprising a rotating jet(s) device which can be easily dismantled for renovation, modification, replacement, cleaning or revision.

### SUMMARY OF THE INVENTION

According to a first aspect, the invention concerns a beverage dispenser in which the beverage is prepared by introducing at least one jet of diluent in a recipient comprising a soluble food ingredient, wherein said dispenser comprises at least one removable rotating jet(s) module comprising:

a motor connectable to an energy supply,

a diluent nozzle able to deliver at least one jet of diluent and connectable to a diluent supply,

a gearing device configured for making the motor rotate the diluent nozzle.

The invention relates to the beverage dispensers preparing a beverage from at least one soluble food or beverage ingredient, either as a liquid or a powder. The food ingredient is delivered in a receptacle and a jet of diluent is introduced in the receptacle for dissolving the ingredient. In order to improve dissolution of the food ingredient and eventually simultaneously frothed the beverage, several jets of diluent can be introduced. The jets of diluent are produced by a nozzle comprising a number of diluent outlets according to the number of jets to be created. According to the invention the dispenser comprises a specific rotating jet(s) module comprising all the means for producing the jet(s) of diluent and rotating said jet(s). Moreover this module is removable from the dispenser without specific tool such as a screwdriver. The operator can remove and reinstall the module by hand.

Generally the dispenser and the removable module present cooperating elements for removable connection of the rotating jet(s) module to the beverage dispenser. Usually the cooperating elements of the rotating jet(s) module are positioned on the module housing. Preferably the cooperating means are clipping means. The rotating jet(s) module can present tongues on the sidewalls of its housing, each of them extending upwardly and being terminated by a hook that can be engaged in a corresponding hole in the dispenser. The tongues can be sufficiently flexible so that a pressure exercised on the hooks is sufficient to enable the disengagement of the hooks from the holes and the removal of the rotating jet(s) module from the dispenser. According to the invention the rotating jet(s) module is not attached to the dispenser by means of screws.

Generally the motor of the module presents an energy supply connecting element and the diluent nozzle presents a diluent supply connecting element. According to the preferred embodiment of the invention said both connecting elements are positioned on the same side of the module. Preferably the both connecting elements are positioned on the upper side of the module. Accordingly the module can be connected to the dispenser according to an upward movement. Usually the energy supply connecting element of the motor is plugged to the energy supply through electric wires and the diluent supply connecting element of the nozzle is plugged to the energy supply through a flexible tube. According to a specific embodiment the both connecting means can be configured for enabling the direct and simultaneous connections of the motor to the energy supply and of the diluent nozzle to the diluent supply. The direct connection means that neither electric wire nor flexible tube is necessary.

According to the preferred embodiment of the invention, the gearing device of the module comprises at least two geared wheels and the at least one diluent nozzle and the motor presents teethed parts that cooperate with said at least two geared wheels. The gearing device can comprise more than two geared wheel depending on the gear ratio that it is desired to use. On the side of the diluent nozzle the teethed part of the at least one diluent nozzle can be a ring surrounding the body of the nozzle. Consequently the engagement of this teethed ring by the geared wheels of the gearing device enables the rotation of the nozzle.

According to the preferred embodiment the diluent nozzle comprises a diluent nozzle supply part, a diluent nozzle geared part and a diluent nozzle outlet part and the diluent nozzle outlet part can be detached from the module. In such an embodiment, the detachable diluent nozzle outlet part can comprise an outer body and an inner body, wherein at least one channel is hollowed in the inner body, wherein the outlet of said at least one channel extend through the bottom of the outer body and slightly project beyond the outer body bottom surface and wherein the outer body comprises an element for removable connection to the diluent nozzle body. The an element for removable connection to the diluent nozzle body usually cooperates with the connection element of the diluent nozzle body. The element for removable connection to the diluent nozzle body can be clipping means, bayonet means or screwing means.

According to a specific embodiment, the diluent nozzle can comprise a non return valve. The valve is preferably positioned in the body of the nozzle placed above the diluent nozzle outlet part.

According to the preferred embodiment, the motor, the diluent nozzle and the gearing device of the rotating jet(s) module are held together by means of a top module half housing and a bottom module half housing, the two half housings being attached together by clipping means. According to the invention the different parts of the rotating jet(s) module are not attached together by means of screws. It means that the operator can dismantle the rotating jet(s) module for repair or cleaning by hand without using a specific tool.

According to one particular embodiment, the beverage dispenser can comprise at least one removable motionless jet module comprising:

a holding device configured for holding and orienting a diluent tube,

at least one connection element for removable connection of said motionless jet module to the beverage dispenser.

This module aims at holding a diluent jet said jet being motionless by opposition to the rotating jet(s) previously described. This module is preferably configured for holding a flexible diluent tube. The holding device can consist in a half tube in which a flexible tube can be easily introduced. The half tube can also be designed so as to orientate the jet of diluent dispensed by the diluent tube, usually to the dispensing area where a drinking cup can be positioned in the dispenser. This motionless jet module presents at least one connection element for removable connection to the dispenser; this connection can be either directly on the dispenser or through the removable rotating jet(s) module. In this last case, the removable rotating jet(s) module and the removable motionless jet module present corresponding connection elements so as to be attached one to the other.

According to a second aspect the invention concerns a method for mounting the dispenser such as described hereabove comprising the steps of:

a) mounting the rotating jet(s) module by:
positioning the nozzle and the gearing device in the bottom module half housing,
positioning the shaft of the motor in the gearing device, and
clipping the upper module half housing with the bottom module half housing,

b) connecting the motor of the module to the energy supply of the dispenser,

c) connecting the nozzle of the module to the diluent supply of the dispenser,

d) connecting the module to the dispenser.

In step b), the motor can be connected to the energy supply by means of electric wires and, in step c), the nozzle can be connected to the diluent supply by means of a flexible tube.

According to a specific embodiment, the steps b, c and d can be implemented simultaneously. In this embodiment no electric wire nor flexible tube has to be connected to the module before connecting it to the dispenser.

### BRIEF DESCRIPTION OF THE DRAWINGS

The characteristics and advantages of the invention will be better understood in relation to

FIG. 1 depicts a side view of a removable module for rotating diluent jets according to the present invention.

FIG. 2 corresponds to FIG. 1 in which the bottom half housing has been deleted,

FIG. 3 is a perspective view of the removable module,

FIG. 4 is a perspective view of the removable diluent nozzle,

FIG. 5 is an exploded view of the removable diluent nozzle,

FIGS. 6A and 6B depict a beverage dispenser with a rotating jet(s) module according to the present invention.

FIG. 7 depicts a removable rotating jets module to which is attached a removable motionless jet module.

### DETAILED DESCRIPTION OF THE DRAWINGS

FIGS. 1 and 3 illustrate a removable module M for rotating diluent jets that can be connected to a beverage dispenser. The module comprises a motor 1 presenting an energy supply connection element 11. The module also comprises a diluent nozzle 2 able to deliver several jets of diluents 23, 24, 25 in a recipient placed below. The diluent nozzle can be connected to a diluent supply through a connection element that is a simple tube 211 in the illustrated module. The both energy supply and diluent supply connecting elements 11, 211 are placed on the same top side of the module to provide an easy connection. In a specific embodiment the connecting elements can be configured to enable the simultaneous connection according to the same vertical direction from downside to upside (such as illustrated by the arrows Z in FIG. 1). The module presents a housing that comprises two parts: a top module half housing 7 and a bottom module half housing 6. The two half housings are connected one to the other by means of clipping means 61, 71 on each of their lateral sides (the lateral side not illustrated by the figures present the same clipping means) and on their front side 62, 72 as made apparent in FIG. 3.

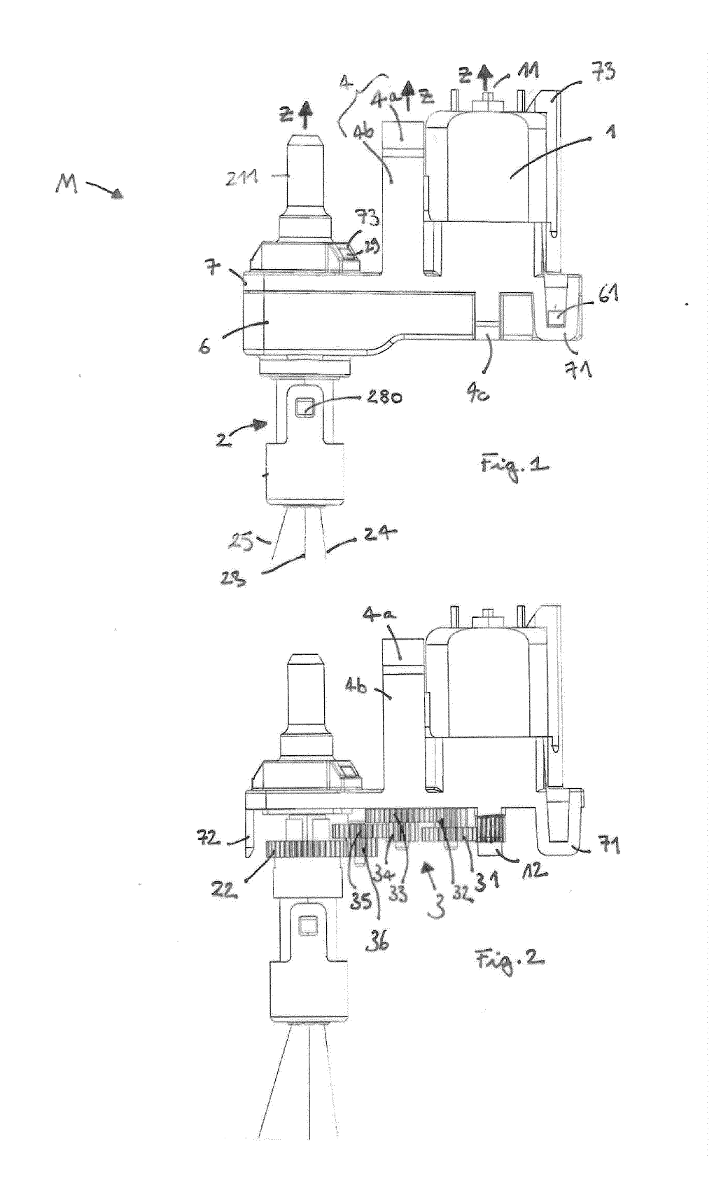

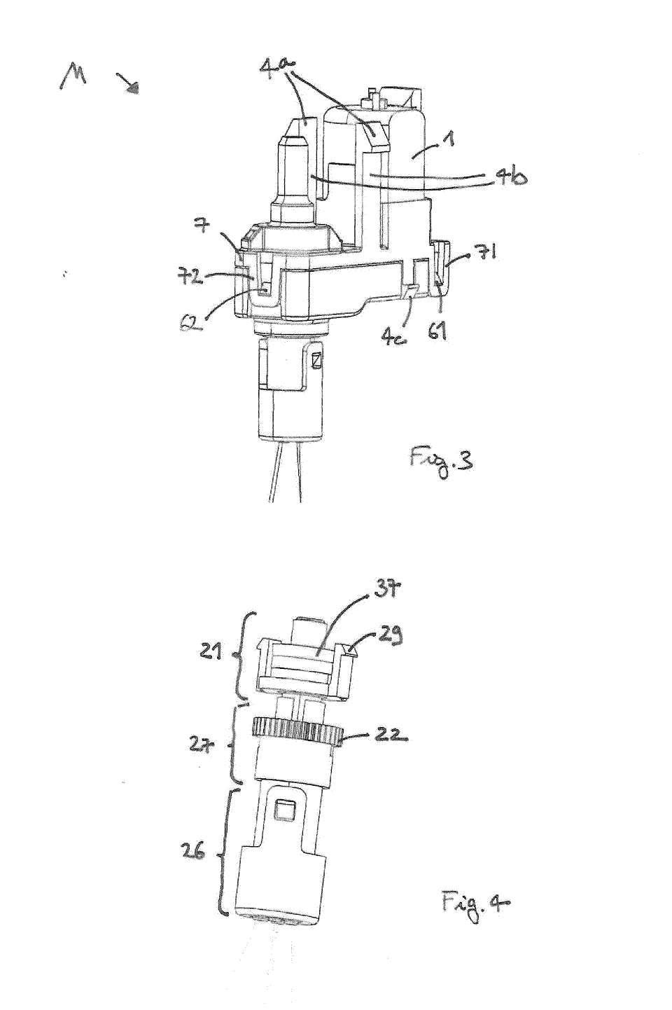

FIG. 2 illustrates the module of FIG. 1 in which the bottom half housing 6 has been made transparent. The gearing device 3 is apparent: it comprises six geared wheels 31, 32, 34, 35, 36 cooperating together. The first geared wheel 31 cooperates with a teethed ring placed around the shaft of the motor 12. The last geared wheel 36 cooperates with a teethed ring 22 placed around the body of the nozzle 2.

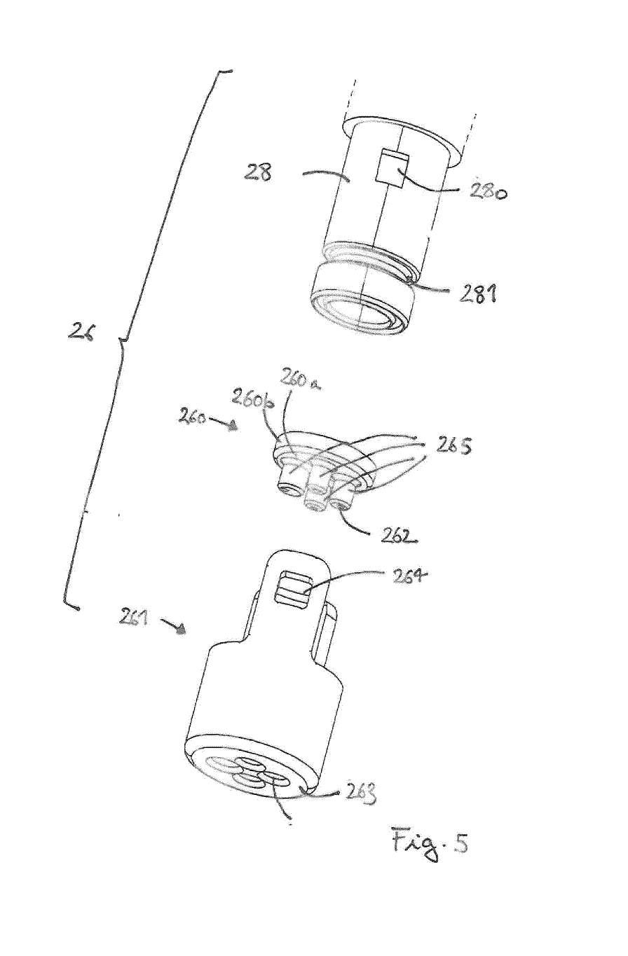

Due to the two half housings 6, 7, the module M can be assembled without using specific tools, in particular without screws and a screwdriver. The different gearing wheels can be positioned in the bottom half housing 6 with the diluent nozzle 2 engaged together, preferably in a space devoted to them, then the top half housing 7 can be connected to the bottom half housing 6 by engaging the respective clippings means 61, 62 with 71, 72. This engagement also forces the engagement of the clipping means 29 of the diluent nozzle (as illustrated in FIG. 4) in the corresponding holes 73 of the top half housing 7.

Lastly the module M presents elements for removable connection to the dispenser. In the illustrated embodiment these elements are clipping means. The rotating jet(s) module presents on each of its lateral walls a tongue 4b extending upwardly and terminated by a hook 4a that can be engaged in a corresponding hole of the dispenser when the module is moved according to the vertical direction Z from downside to upside. The tongues 4b can be sufficiently flexible so that a pressure on them is sufficient to enable the disengagement of the hook 4a from the hole and the removal of the rotating jet(s) module M from the dispenser.

FIG. 4 illustrates the diluent nozzle 2 that is placed in the rotating jet(s) module M. The nozzle is composed of three parts: a diluent nozzle supply part 21, a diluent nozzle geared part 27 and a diluent nozzle outlet part 26. At the diluent nozzle supply part 21, the nozzle comprises clipping means 29 for engagement in holes 73 of the top half housing 7. This engagement enables the good axial positioning of the lip seal 37. The diluent nozzle outlet part 26 can be detached from the module M.

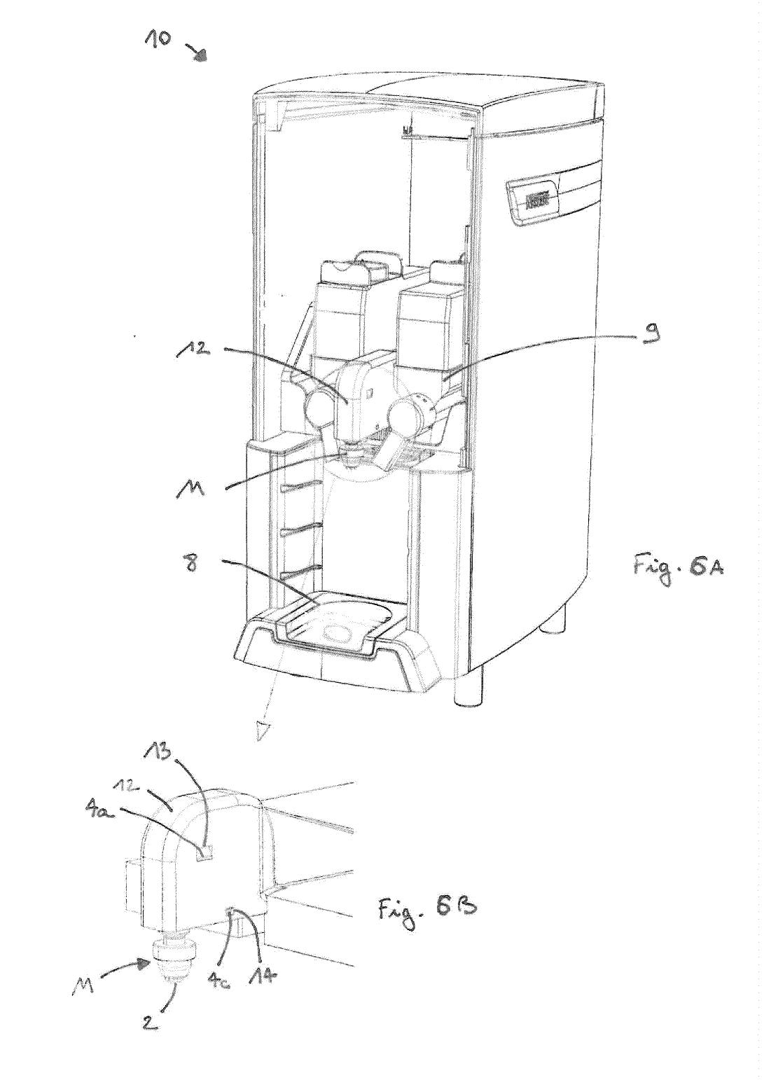

FIG. 5 represents an exploded view of the diluent nozzle outlet part 26. The outlet part comprises an outer body 261 that is generally made of a rigid material like a plastic (e.g. PA: polyamide). This outer body is generally a cylinder of which top extremity is opened and of which bottom extremity is closed by a plate with traversing holes 263 in which sub-nozzles 265 can be positioned. The outlet part comprises also an inner body 260 wherein the channels of the 4 nozzles 265 are hollowed. The inner body present the shape of a plate 260b and the outlets 262 of the nozzles channels jut out of the bottom surface of said plate. During manufacturing the orientation of each of the channels can be designed in order to get a specific hitting of the diluent jets in the final cup. The length of the channels of the nozzles jutting out the inner body bottom surface 260a and the thickness of the bottom extremity of the outer body are designed so that the channels of the nozzles slightly project beyond the outer body bottom surface 260a. The inner body 260 is generally made of a soft material. The plate part 260b of the inner body usually presents dimensions such that it is able to slide in and out of the outer body 261 for manufacturing and for maintenance or cleaning. It presents the smallest thickness as possible to limit manufacturing cost due to the nature of the soft material.

The diluent outlet part also presents elements 264 for removable connection to the diluent nozzle body 28 and cooperating with connections elements 280 in the nozzle body. The connection elements of the diluent nozzle outlet part are preferably integrated in the outer body 261. In the illustrated example the connection element is made of two holes 264 in which two corresponding studs 280 of the diluent nozzle body can slide and enter to maintain the nozzle outlet part. The dimensions and shapes of the two corresponding elements are designed so that the assembly of nozzles can be dismantled from the liquid supply. Any other types of connection element could be used, e.g. the outer body 261 can be threaded on the body 28 through corresponding threads. Preferably the nozzle body 260 presents a circular slot 281 in which an o-ring seal can be placed in order to guarantee water tightness during the delivery of a fluid through the nozzles.

Due to the fact that the inner body 260 is removable from the outer body, it can be replaced by another inner body presenting different orientations of the four sub-nozzles e.g. to adapt the beverage mixing device to different cup shapes or sizes for example or for thoroughly cleaning the inner and the outer body if food ingredients have projected against them during beverage preparation. It is also possible to replace the whole nozzles assembly by another one presenting a different number of nozzles with various orientations for example for dealing with the dissolution of specific food ingredients. The beverage dispensing machine can be rapidly upgraded without dismantling the whole module.

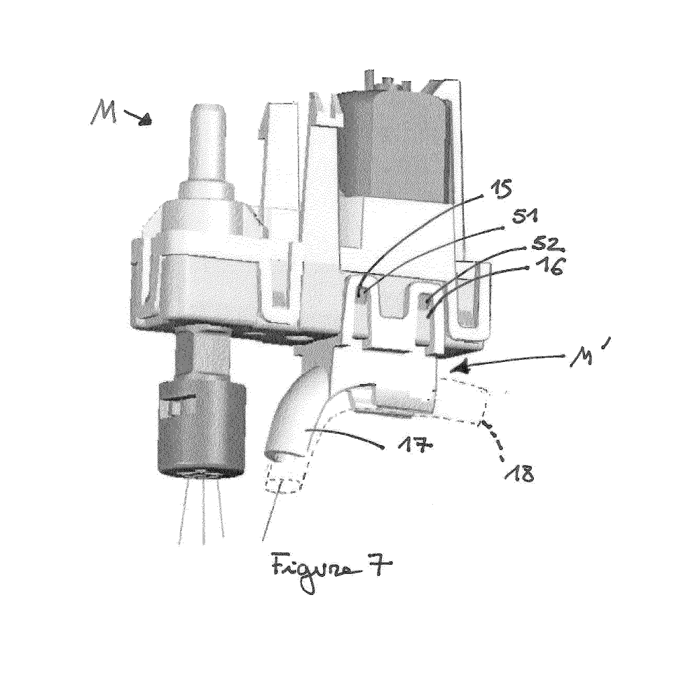

FIG. 6A illustrates a beverage dispenser 10 of which front door has been removed to show its inside arrangement. In the housing the dispenser comprises a dispensing area 8 on which a cup can be placed to receive the prepared beverage. The dispenser also comprises two identical storing and dosing modules 9: each of them comprises a tank for storing the food ingredient, a dosing device for delivering the ingredient to the cup through a chute. The rotating jet(s) module M is positioned between the both storing and dosing modules 9. It is attached to an inside support element 12 of the dispenser presenting elements cooperating with the elements for removable connection 4 of the rotating jet(s) module. These elements are holes 13, 14 in the support 12 in which the hooks 4a, 4c of the module can slide and retain the module in a fixed position such as illustrated in FIG. 5B. These holes are positioned in the support 12 so that once fixed the diluent nozzle 2 of the module is placed vertically above the dispensing area 8.

The module of the present invention can also be used in dispensers where the food or beverage ingredients are introduced in the recipient by other means than the illustrated storing and dosing modules. For example the ingredient can be introduced in the recipient by the customer itself using a powder stick or the recipient may comprise a single dose of soluble ingredient at the bottom of the cup covered by an opercule that is detachably sealed to the internal surface of the cup and that packs that food ingredient in the bottom portion of the cup (such as described in WO 2008/003570).

FIG. 7 depicts a particular embodiment of the present invention wherein a removable motionless jet module M′ is attached to the removable rotating jets module M. According to the invention this module M′ can also be attached to the frame of the dispenser separately from module M. Module M′ presents a half tube 17 opened at its bottom part such that a flexible tube 18 (illustrated in dotted line) can be slid and held inside. The half tube is also designed so that the outlet of the flexible tube delivers a diluent jet in the dispensing area of the dispenser where a drinking cup can be placed. Module M′ is attached to module M in a removable manner. Module M′ presents holes 15, 16 in its support in which the hooks 51, 52 of module M can slide and retain module M′ in a fixed position such as illustrated in FIG. 7. These holes and hooks are positioned in the both modules M, M′ so that once fixed the half tube 17 orientate the flexible tube outlet to the dispensing area 8. This module M′ enables the delivery of a motionless diluent jet which can be of interest when it is desired to produce a beverage without foam like a tea beverage. For the preparation of such a beverage diluent can be delivered only by the tube 18 and not by the diluent nozzle 2.

The dispenser of the present invention presents the advantages of presenting a rotating jet(s) module that can be easily disconnected from the dispenser without tool for being repaired, cleaned, controlled or replaced by another new module. It becomes easy to disconnect the module for cleaning it or for replacing it by another module if the dispenser has to handle different concentrates or has to prepare beverages in recipient of different shape.

The rotating jet(s) module of the dispenser of the present invention also presents the advantage of being assembled in a very simply method without need of specific tools. All the elements can be clipped together by hand which saves manufacturing costs and operation costs when the module has to be cleaned, repaired or renovated.

The diluent nozzle of the module presents the advantage of enabling the replacement of its inner body by another one with a different orientation of the nozzles relatively to the cup. Such a replacement can be useful if different cup shapes are used or if a different dissolution profile is desired (different foam, different beverage powder quality, . . . ). Again the dispenser can be renovated without use of specific tool in very simply way.

In the same way another advantage is the possibility to introduce the removable motionless jet module in the dispenser to upgrade the dispenser if desired or to remove this module from the dispenser for cleaning or maintenance.

1. Beverage dispenser in which the beverage is prepared by introducing at least one jet of diluent in a recipient comprising a soluble food ingredient, the dispenser comprises at least one removable rotating jet module comprising:
a motor connectable to an energy supply;
a diluent nozzle able to deliver at least one jet of diluent and connectable to a diluent supply; and
a gearing device configured for making the motor rotate the diluent nozzle.

2. Beverage dispenser according to claim 1, wherein the dispenser and the removable module comprise cooperating elements for removable connection of the module to the beverage dispenser.

3. Beverage dispenser according to claim 2, wherein the cooperating elements of the module are positioned on the module housing.

4. Beverage dispenser according to claim 2, wherein the cooperating elements are able to be clipped together.

5. Beverage dispenser according to claim 1, wherein the rotating jet module is not attached to the dispenser by means of screws.

6. Beverage dispenser according to claim 1, wherein:
the motor presents an energy supply connection element;
the diluent nozzle presents a diluent supply connection element; and
wherein the both connection elements are positioned on the same side of the module.

7. Beverage dispenser according to claim 1, wherein the energy supply and the diluent supply connection elements are positioned on the upper side of the module.

8. Beverage dispenser according to claim 6, wherein the energy supply and the diluent supply connection elements are configured for enabling the simultaneous connection of the motor to the energy supply and of the diluent nozzle to the diluent supply.

9. Beverage dispenser according to claim 1, wherein the gearing device comprises at least two geared wheels and the diluent nozzle and the motor present tooth parts that cooperate with the at least two geared wheels.

10. Beverage dispenser according to claim 9, wherein the tooth part of the diluent nozzle is a ring surrounding the body of the nozzle.

11. Beverage dispenser according to claim 1, wherein the diluent nozzle comprises a diluent nozzle supply part, a diluent nozzle geared part and a diluent nozzle outlet part and wherein the diluent nozzle outlet part can be detached from the module.

12. Beverage dispenser according to claim 11, wherein the detachable diluent nozzle outlet part comprises an outer body and an inner body, wherein at least one channel is hollowed in the inner body, wherein the outlet of the at least one channel extend through the bottom of the outer body and slightly project beyond the outer body bottom surface and the outer body comprises an element for removable connection to the diluent nozzle body.

13. Beverage dispenser according to claim 12, wherein the removable connection element to the diluent nozzle body cooperates with a connection element of the diluent nozzle body.

14. Beverage dispenser according to claim 12, wherein the removable connection elements to the diluent nozzle body are able to be connected together by clipping, screwing or through a bayonet system.

15. Beverage dispenser according to claim 1, wherein the diluent nozzle comprises a non return valve.

16. Beverage dispenser according to claim 1, wherein the motor, the diluent nozzle and the gearing device of the rotating jet module are held together by means of a top module half housing and a bottom module half housing, the two half housings being attached together by clipping elements.

17. Beverage dispenser according to claim 1, wherein the different parts of the rotating jet module are not attached together by means of screws.

18. Beverage dispenser according to claim 1, wherein it comprises comprising at least one removable motionless jet module comprising:
a holding device configured for holding and orienting a diluent tube: and
connection elements for removable connection of the motionless jet module to the beverage dispenser.

19. Method for mounting a dispenser in which the beverage is prepared by introducing at least one jet of diluent in a recipient comprising a soluble food ingredient, the dispenser comprises at least one removable rotating jet module comprising a motor connectable to an energy supply, a diluent nozzle able to deliver at least one jet of diluent and connectable to a diluent supply, and a gearing device configured for making the motor rotate the diluent nozzle comprising the steps of:
mounting the rotating jet module by:
positioning the nozzle and the gearing device in the bottom module half housing,
positioning the shaft of the motor in the gearing device, and
clipping the upper module half housing with the bottom module half housing;
connecting the motor of the module to the energy supply of the dispenser;
connecting the diluent nozzle of the module to the diluent supply of the dispenser; and
connecting the module to the dispenser.

20. Method according to claim 19, wherein:
the motor is connected to the energy supply by use of electric wires; and
the nozzle is connected to the diluent supply by use of a flexible tube.

21. Method according to claim 19, wherein the steps of connecting the motor, the diluent nozzle, and module are implemented simultaneously.
